(19) United States
(12) Patent Application Publication
(10) Pub. No.: US 2025/0008579 A1
(43) Pub. Date: Jan. 2, 2025

(54) Connection Establishment for Short-Range Communications

(71) Applicant: Apple Inc., Cupertino, CA (US)

(72) Inventors: Chen GANIR, San Jose, CA (US); Duy N. PHAN, Los Gatos, CA (US); Jiawei CHEN, San Diego, CA (US); Michael GILES, San Jose, CA (US); Rahul SARNA, Sunnyvale, CA (US)

(21) Appl. No.: 18/756,503

(22) Filed: Jun. 27, 2024

Related U.S. Application Data
(60) Provisional application No. 63/510,516, filed on Jun. 27, 2023.

(51) Int. Cl. H04W 76/10; H04W 8/22; H04W 12/03

(52) U.S. Cl. CPC H04W 76/10; H04W 8/22; H04W 12/03

(57) ABSTRACT

An apparatus configured to generate, for transmission to a device, first connection related information associated with establishing a short-range communication link, process, based on signals received from the device, second connection related information associated with establishing the short-range communication link with the device, establish the short-range communication link with the device using the first connection related information and the second connection related information, wherein the establishing further comprises the processing circuitry being configured to generate, for transmission to the device, an indication the apparatus supports a fast connection process, generate, for transmission to the device, an indication the apparatus comprises the second connection related information, process, based on signals received from the device, an indication the wireless device supports the fast connection process and process, based on signals received from the device, an indication the device comprises the first connection related information.

### PRIORITY/INCORPORATION BY REFERENCE

This application claim priority to U.S. Provisional Application Ser. No. 63/510,516 filed on Jun. 27, 2023, entitled, “Connection Establishment for Short-Range Communications,” the entirety of which is incorporated by reference herein.

### BACKGROUND

A short-range communication protocol enables a short-range communication to be exchanged between two or more devices. One such short-range communication protocol has been defined as Bluetooth low energy (hereinafter referred to as “BLE”). When a BLE connection is created between two Bluetooth Special Interest Group (BT SIG) compliant devices, the devices must follow a predefined flow of events and messages that need to be exchanged to allow for the establishment of a stable and reliable connection and to ensure the maximum over-the-air transfer rate is used. Establishing this connection to reliably and safely send data between these devices can take an amount of time that is frustrating to users and leads to a bad user experience.

### SUMMARY

Some example embodiments are related to an apparatus having processing circuitry configured to generate, for transmission to a device, first connection related information associated with establishing a short-range communication link, process, based on signals received from the device, second connection related information associated with establishing the short-range communication link with the device, establish the short-range communication link with the device using the first connection related information and the second connection related information, wherein to establish the short-range communication link the processing circuitry is configured to generate, for transmission to the device, an indication the apparatus supports a fast connection process, generate, for transmission to the device, an indication the apparatus comprises the second connection related information, process, based on signals received from the device, an indication the wireless device supports the fast connection process and process, based on signals received from the device, an indication the device comprises the first connection related information.

Other example embodiments are related to an apparatus having processing circuitry configured to process, based on signals received from a device, an indication the device supports a fast connection process for a short-range communication link, process, based on signals received from the device, an indication the second device does not comprise first connection related information associated with establishing the short-range communication link with the first device, generate, for transmission to the device, an indication the apparatus supports the fast connection process, generate, for transmission to the device, an indication the apparatus does not comprise second connection related information associated with establishing the short-range communication link with the device, generate, for transmission to the device, a first aggregated link layer message comprising a complete set of the first connection related information to establish the short-range communication link with the device, process, based on signals received from the device, a second aggregated link layer message comprising a complete set of the second connection related information to establish the short-range communication link with the device and establish the short-range communication link with the device using the first and second connection related information.

Still further example embodiments are related to an apparatus having processing circuitry configured to generate, for transmission to a device, an indication the apparatus supports a fast connection process, generate, for transmission to the device, an indication the apparatus comprises first connection related information for the fast connection process, process, based on signals received from the device, an indication the device supports the fast connection process; and process, based on signals received from the device, an indication the device comprises second connection related information.

### BRIEF DESCRIPTION OF THE DRAWINGS

FIG. 1 shows an arrangement of components utilizing short-range communication links according to various example embodiments.

FIG. 2 shows a device for establishing a short-range communication link according to various example embodiments.

FIG. 3 shows a call flow diagram for establishing a short-range communication link using out-of-band (OOB) exchange of the controller capabilities and features according to various example embodiments.

FIG. 4 shows a call flow diagram for establishing a short-range communication link using an over-the-air (OTA) exchange of the controller capabilities and features in an aggregated link layer message according to various example embodiments.

### DETAILED DESCRIPTION

The example embodiments may be further understood with reference to the following description and the appended drawings, wherein like elements are referred to with the same reference numerals. The example embodiments relate to manners of establishing a short-range communication link between two devices. Specifically, in a first aspect, the short-range communication link is established based on an out-of-band (OOB) exchange of connection information between the two devices. In a second aspect, the short-range communication link is established based on an over-the-air (OTA) exchange of connection information between the two devices. Each of these aspects will be described in greater detail below.

The example embodiments are described herein with regard to establishing a short-range communication link (or connection) where the short-range communication link is a Bluetooth link. Specifically, the example embodiments are described with reference to establishing a Bluetooth Low Energy (BLE) connection. However, the use of the BLE link or a Bluetooth link in general is only example and the Bluetooth link may represent (or be replaced by) any short-range communication link. Furthermore, the use of a short-range communication link is also only an example, and the example embodiments may be used or modified for any type of connection between two or more devices (e.g., a medium- or long-range connection).

The example embodiments are described with reference to example call flows. In the example call flows, various messages are described with reference to specific message names. Any message names are only examples and messages that have other names (or no names at all) may be used to convey the information included in the various messages.

BLE or “Bluetooth Smart” is a wireless personal area network (PAN) technology designed and marketed by the BT SIG aimed at applications in the healthcare, fitness, location, beacon, security, and home entertainment industries. Compared to Classic Bluetooth (or Bluetooth Classic) that includes the Bluetooth paging/page scan operations, BLE is intended to provide considerably reduced power consumption and cost while maintaining a similar communication range as well as reducing a time used by Bluetooth devices to identify proximity and capability of establishing a Bluetooth connection. However, even with the BLE protocol being used, connection establishment requires a predefined order of events and messages to be exchanged between devices to allow a stable and reliable connection. The current connection establishment takes too much time and results in a poor user experience when devices are connecting.

The example embodiments are configured to reduce the amount of time for devices to establish a short-range communication link. Specifically, the example embodiments introduce a fast connection process for establishing the short-range communication link. There may be no specific time associated with the fast connection process but that term is merely used to distinguish the connection process for a standard connection process, e.g., the standard BLE connection process.

As will be described in further detail below, there are various aspects to the fast connection process. In a first aspect, the fast connection process is based on an OOB exchange of connection information between the two devices that are to be connected. The OOB exchange refers to an exchange that does not occur on the short-range communication link or during the establishment of the short-range communication link between the devices. This OOB exchange may be a direct exchange, e.g., via a wired or wireless connection between the devices, or an indirect exchange where the devices write the connection information to a cloud service and the peer device retrieves the connection information from the cloud service. This OOB exchange allows a faster connection because the devices do not need to exchange the connection information during the connection establishment process.

In a second aspect, the fast connection process is based on an OTA message exchanged between the devices during the connection process. The OTA message may be an aggregated link layer message that includes all the connection information needed to establish the short-range communication link. This aggregated message replaces multiple individual messages and allows a faster connection because multiple messages are eliminated from the standard connection process. Each of these aspects are described in greater detail below.

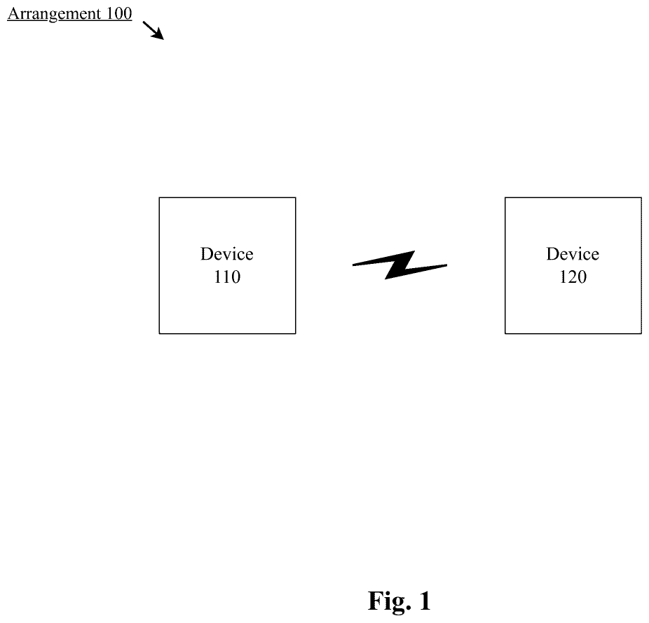

FIG. 1 shows an arrangement 100 of components utilizing short-range communication links according to various example embodiments. The arrangement 100 shows a first device 110 and a second device 120 that are both capable of establishing a short-range communication link, e.g., a BLE communication link. In this example, the devices 110 and 120 are shown as having a mutual relationship (e.g., peer to peer) where neither component has a priority (e.g., sharing an equal priority) or neither component has predetermined operations that must be performed (e.g., the predetermined operations may have shared or the duty to perform may be shared). However, in some arrangements one of the devices (e.g., the device 110) may be a primary device and the other one of the devices (e.g., the device 120) may be a secondary device. In some example embodiments, the primary/secondary relationship may be dynamically set. Furthermore, the PAN including the devices 110 and 120 may also include further devices, e.g., the PAN is not limited to two devices. In this example, it may be considered that the devices 110 and 120 are not currently connected. Rather, the example embodiments will provide examples of connection establishment flows for connecting the devices 110 and 120.

The devices 110 and 120 may be any electronic device capable of establishing a short-range communication link. For example, the devices 110 and 120 may be a mobile device (e.g., a mobile computing device, a mobile phone, a tablet computer, a personal computer, a VoIP telephone, a personal digital assistant, a wearable, a peripheral, an Internet of Things (IoT) device, etc.) or a stationary device (e.g., a desktop terminal, a server, an IoT device, etc.). The example embodiments may be used to establish a short-range communication link between any type(s) of device(s).

In establishing the short-range communications link, the devices 110 and 120 may include the necessary hardware, software, and/or firmware to perform conventional operations as well as operations according to the example embodiments.

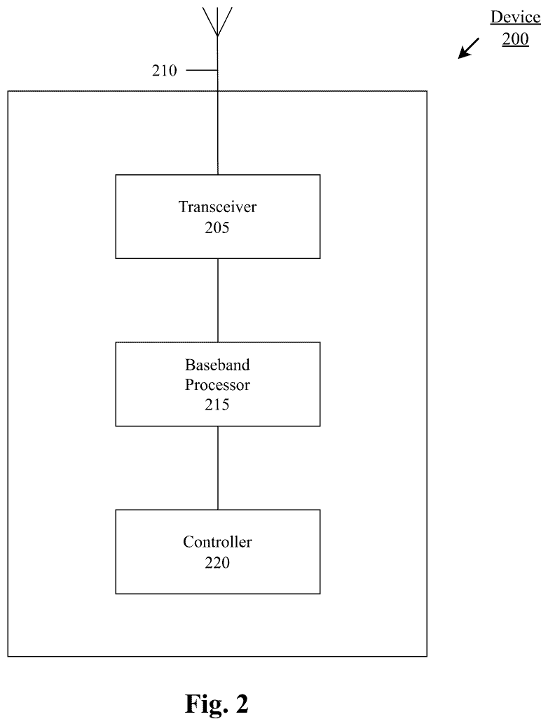

FIG. 2 shows a device 200 for establishing a short-range communication link according to various example embodiments. The device 200 may represent any of the devices 110 or 120. Specifically, the device 200 may represent the components that may be included to perform the operations according to the example embodiments.

The device 200 may include a transceiver 205 connected to an antenna 210, a baseband processor 215, and a controller 220, as well as other components (not shown). The other components may include, for example, a memory, an application processor, a battery, ports to electrically connect the device 200 to other electronic devices, etc. The transceiver 205 may be configured to exchange data over one or more connections. Specifically, the transceiver 205 may enable a short-range communication link to be established using frequencies or channels associated with the short-range communication protocol (e.g., the channels associated with a Bluetooth connection). The controller 220 may control the communication functions of the transceiver 205 and the baseband processor 215. In addition, the controller 220 may also control non-communication functions related to the other components, such as the memory, the battery, etc. Accordingly, the controller 220 may perform operations associated with an applications processor. The transceiver 205 includes circuitry configured to transmit and/or receive signals (e.g., control signals, data signals). Such signals may be encoded with information implementing any one of the methods described herein. The baseband processor 215 and the controller 220 may be operably coupled to the transceiver 205 and configured to receive from and/or transmit signals to the transceiver 255. The baseband processor 215 and the controller 220 may be configured to encode and/or decode signals for implementing any one of the methods described herein.

The baseband processor 215 and the controller 220 may be one or more integrated circuits (e.g., chip(s)) compatible with a wireless communication standard, such as BLE. The baseband processor 215 and the controller 220 may be configured to execute a plurality of operations of the device 200. For example, the operations may include the methods and operations related to the OOB exchange or OTA exchange of connection related information to establish a short-range communication link.

In a first aspect, the example embodiments are related to an out-of-band (OOB) exchange of the controller capabilities and features to be used in establishment of the short-range communication link (referred to herein as connection related information). Examples of connection related information related to establishing a short-range communication link between the devices may include version (e.g., BT Version 1-5, manufacturer of the BT chipset, etc.), features (e.g., any of the twenty eight (28) features supported BT version 5.1), enhanced data packet length capabilities (e.g., EDL capability) and physical layer (PHY) capabilities. This connection related information is only an example and additional connection related information, alternate connection related information or less than the connection related information examples provided above may be exchanged between the devices. That is, any information related to establishing a short-range communication link between the devices may be exchanged using the OOB exchange.

In the present example, it may be considered that the devices that may establish the short-range communication link may be the devices 110 and 120 of FIG. 1. There may be various manners of performing the OOB exchange of connection related information between the devices 110 and 120. In one example, the devices 110 and 120 may share the connection related information using a connection that is not a BT connection. This connection may be a wireless connection or a wired connection. For example, the devices 110 and 120 may exchange the connection related information when connected via a wireless connection such as WiFi, near field connection (NFC), cellular, etc. In other examples, the devices 110 and 120 may have a USB connection (or other wired connection) and exchange the connection related information using the wired connection.

In another example, the OOB exchange of connection related information may be performed via a cloud service. For example, it may be considered that the devices 110 and 120 may both be associated with the same user's account. For example, the device 110 may be a tablet computer and the device 120 may be a peripheral (e.g., electronic pen, second display, etc.) that may be used with the tablet computer. The user may have both of the devices 110 and 120 registered with an account associated with the user (or any other manner of associating devices with the user). For example, the manufacturer or seller of the devices 110 and 120 may host a cloud service that allows users to associate devices with the user's account such that the devices are aware of the other devices that are also associated with the account. This cloud service may store and/or push data associated with the various devices to other devices associated with the account. For example, when a device (e.g., the device 110) associates with the cloud account, various data associated with the device may be stored in the cloud account including the connection related information. This may allow other devices associated with the cloud account (e.g., the device 120) to retrieve the data associated with the device. Similarly, the device 110 may retrieve the data associated with the device 120 via the cloud account. Example manners of managing the information in the cloud account will be described in greater detail below.

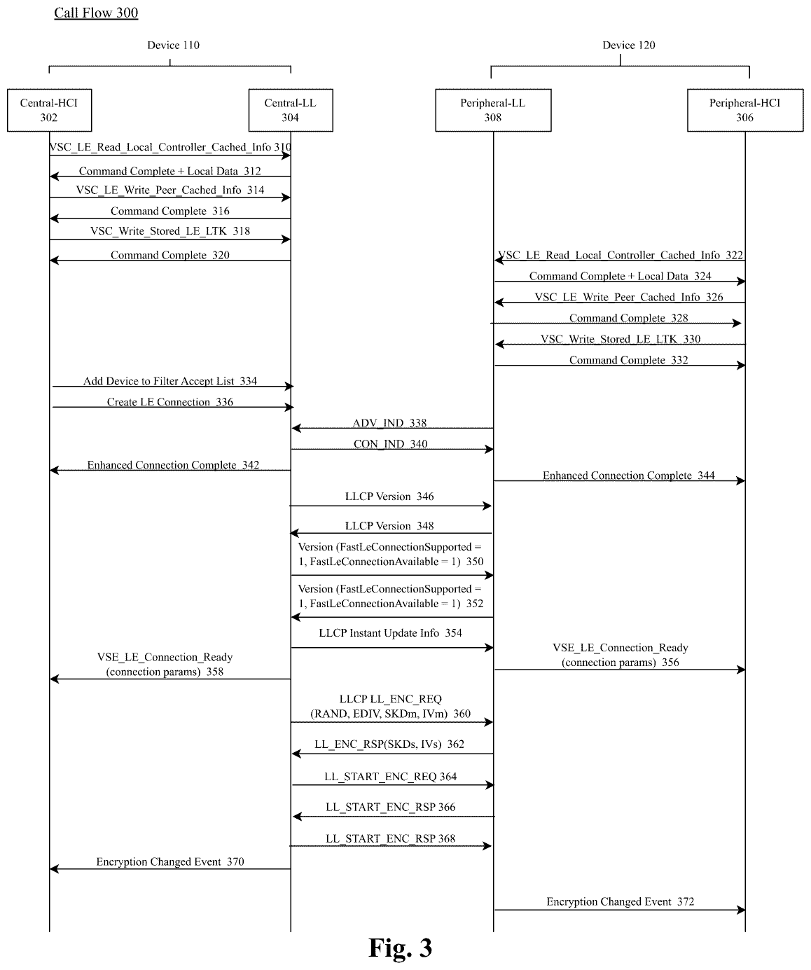

FIG. 3 shows a call flow diagram 300 for establishing a short-range communication link using out-of-band (OOB) exchange of the controller capabilities and features according to various example embodiments. In the example of FIG. 3, it may be considered that the devices that are establishing the connection are the devices 110 and 120 of FIG. 1, e.g., the device 110 may be considered to be the central device such as the tablet computer in the above example and the device 120 may be considered to be the peripheral device such as the electronic pen in the above example. In addition, the devices 110 and 120 may also be referred to as peer devices in the below description.

The device 110 comprises a central host controller interface (HCI) 302 and a central link layer (LL) 304. The device 110 (e.g., using the baseband processor 215) may execute a BT stack that includes the LL 304. The HCI 302 is a layer that transports commands between the host and the controller (e.g., the controller 220). Any messages exchanged between the central HCI 302 and the LL 304 in the call flow 300 may occur within the device 110. Similarly, the device 120 comprises a peripheral HCI 306 and a peripheral LL 308 and any messages exchanged between the peripheral HCI 306 and the peripheral LL 308 in the call flow 300 may occur within the device 120.

The call flow 300 assumes that the devices (e.g., the devices 110 and 120) have exchanged the respective connection related information prior to the call flow 300, e.g., the call flow 300 is not showing the OOB exchange of connection related information but rather the connection establishment operations when the devices have obtained the connection related information.

In 310, the connection related information of the device 110 is read from the central HCI 302 by the central LL 304, e.g., the device 110 reads its own connection related information. In 312, the central LL 304 confirms the reading of the connection related information is complete.

In 314, the connection related information for the peer device (e.g., the device 120) is written by the central HCI 302 to the central LL 304. As described above, at some point prior to 314, the device 110 has obtained the connection related information for the device 120, e.g., via one or more of the OOB methods described above. In 316, the central LL 304 confirms the writing of the connection related information for the peer device is complete.

In addition to the connection related information, the devices may also exchange information related to encryption for communications over the BLE link to be established. There is no requirement that encryption information be exchanged but the exchange of encryption information may further speed connection establishment because the encryption information does not need to be exchanged. The encryption information may include, for example, a long term key (LTK) to be used with a particular peer device. Thus, in 318, the central HCI 302 may write encryption information (e.g., an LTK) for the peer device (e.g., the device 120) to the central LL 304. In 320, the central LL 304 confirms the writing of the encryption information for the peer device is complete.

The operations 322-332 performed by the device 120 are similar to the operations 310-320 performed by the device 110 and will be briefly described. In 322, the connection related information of the device 120 is read from the peripheral HCI 306 by the peripheral LL 308, e.g., the device 120 reads its own connection related information. In 324, the peripheral LL 304 confirms the reading of the connection related information is complete.

In 326, the connection related information for the peer device (e.g., the device 110) is written by the peripheral HCI 306 to the peripheral LL 308. As described above, at some point prior to 326, the device 120 has obtained the connection related information for the device 110. In 328, the peripheral LL 304 confirms the writing of the connection related information for the peer device is complete. In 330, the peripheral HCI 306 may write encryption information (e.g., an LTK) for the peer device (e.g., the device 110) to the peripheral LL 308. In 332, the peripheral LL 308 confirms the writing of the encryption information for the peer device is complete.

In 334, the central HCI 302 adds the peer device for which it has received connection related information to a filter accept list of the central LL 304, e.g., e.g., indicating that the device 110 may connect to the device 120 using a short-range communication link. In 336, the central HCI 302 creates a connection for the peer device with the central LL, e.g., there is a socket indicating that any connection with the peer device should be created using a particular type of connection, in this example, a BLE connection.

In 338, the peripheral LL 308 performs a BLE advertisement operation. The BLE advertisement operation is a standard BLE advertising operation. In 340, the central LL 304 performs a BLE connection indication response to the advertisement of 338. Again, the BLE connection response is a standard BLE operation that includes a connection request packet sent on one of the primary advertising channels.

In 342, the central LL 304 reports to the central HCI 302 that an enhanced connection is complete. This is again a standard BLE operation that indicates a resolved public address once connected to a public peer address. In 344, the device 120 performs a corresponding operation as 342 for the device 110, the peripheral LL 308 reports to the peripheral HCI 306 that an enhanced connection is complete.

In 346, the central LL 304 indicates to the peripheral LL 308 the Link Layer Control Protocol (LLCP) version used by the device 110. Similarly, in 348, the peripheral LL 308 indicates to the central LL 304 the LLCP version used by the device 120.

In 350, the central LL 304 indicates to the peripheral LL 308 a status of support for fast connection by the device 110 in a version message. The version message may be a new message or it may be an existing version message (e.g., from a standard BLE connection process) that includes additional bits to indicate support for the fast connection. The support comprises two indications. The first indication is whether fast connection is supported by the device 110, e.g., one of the bits in the version message is set to 1 if the device 110 supports a fast connection and 0 if the device 110 does not support fast connection. The second indication is whether the device 110 is available for fast connection, e.g., does the device 110 have the connection related information for the peer device 120. Again, for example, if the device 110 has the connection related information for the peer device 120, the bit may be set to 1 and if the device 110 does not have the connection related information for the peer device 120 the bit may be set to 0.

In 352, the peripheral LL 308 indicates to the central LL 304 a status of support for fast connection by the device 120 in a version message, e.g., the corresponding operation to the operation 350 performed by the device 110.

For the fast connection to be used, both indications for both devices will be set to positive, e.g., the devices 110 and 120 both support fast connection and have the connection related information for the peer device. In this example, this will be considered and described below. However, if any of the indications are negative, fast connection will not be used and the devices 110 and 120 will fall back to use the standard BLE connection process.

In this example, it may be considered that the indications in the version message for both devices 110 and 120 are positive, e.g., the devices 110 and 120 both support fast connection and have the connection related information for the peer device. Thus, in this example, at the completion of 352, the device 110 has the connection related information for the device 120, is aware that the device 120 supports fast connection, and the device 120 has the connection related information for the device 110. Similarly, at the completion of 352, the device 120 has the connection related information for the device 110, is aware that the device 110 supports fast connection, and the device 110 has the connection related information for the device 120. Thus, fast connection may be used for connecting the devices 110 and 120 via a short-range communication link (e.g., BLE link).

In 354, the central LL 304 sends an LLCP instant update message to the peripheral LL 308. The LLCP instant update message indicates a time at which the devices 110 and 120 should apply the connection related information for the purposes of the fast connection. As described above, the fast connection allows the devices 110 and 120 to connect based on the connection related information stored by the devices 110 and 120 without performing various messaging to exchange the connection related information. Thus, when the central LL 304 sends the LLCP instant update message in 354 with the timing to apply the connection related information, the devices 110 and 120 may then apply the corresponding connection related information to create the short-range communication link.

Thus, in 356, the peripheral LL 308 will send a connection ready message including the connection related information to the peripheral HCI 306 and in 358 the central LL 304 will send a connection ready message including the connection related information to the central HCI 302 and the devices 110 and 120 will have established the short-range communication link.

The remaining operations of the call flow 300 are related to scenarios where the devices 110 and 120 have also exchanged encryption information. The encryption information does not need to be exchanged for the purposes of performing the fast connection. However, the exchange of the encryption information may save additional time for short-range communication links that use encryption, e.g., the encryption information does not need to be exchanged during connection establishment.

In 360, the central HCI 302 sends an encryption request using the stored encryption information (e.g., the LTK corresponding to the device 120) to the peripheral LL 308. In 362, the peripheral LL 308 sends an encryption response using the stored encryption information (e.g., the LTK corresponding to the device 110) to the central LL 304. In 364, the central LL 304 then sends a start encryption request to the peripheral LL 308. In 366, the peripheral LL 308 sends a start encryption response to the central LL 304. In 368, the central LL 304 sends a start encryption response to the peripheral LL 308.

In 370, the central LL 304 sends an encryption changed event message to the central HCI 302 indicating that messages exchanged over the short-range communication link may use encryption based on the stored encryption information. Similarly, in 372, the peripheral LL 308 sends an encryption changed event message to the peripheral HCI 306 indicating that messages exchanged over the short-range communication link may use encryption based on the stored encryption information.

In a second aspect, the example embodiments are related to an over-the-air (OTA) exchange of the controller capabilities and features in an aggregated link layer message to be used in establishment of the short-range communication link. The connection related information to be used for the fast connection in the second aspect of the example embodiments may be similar to the connection related information described above for the first aspect.

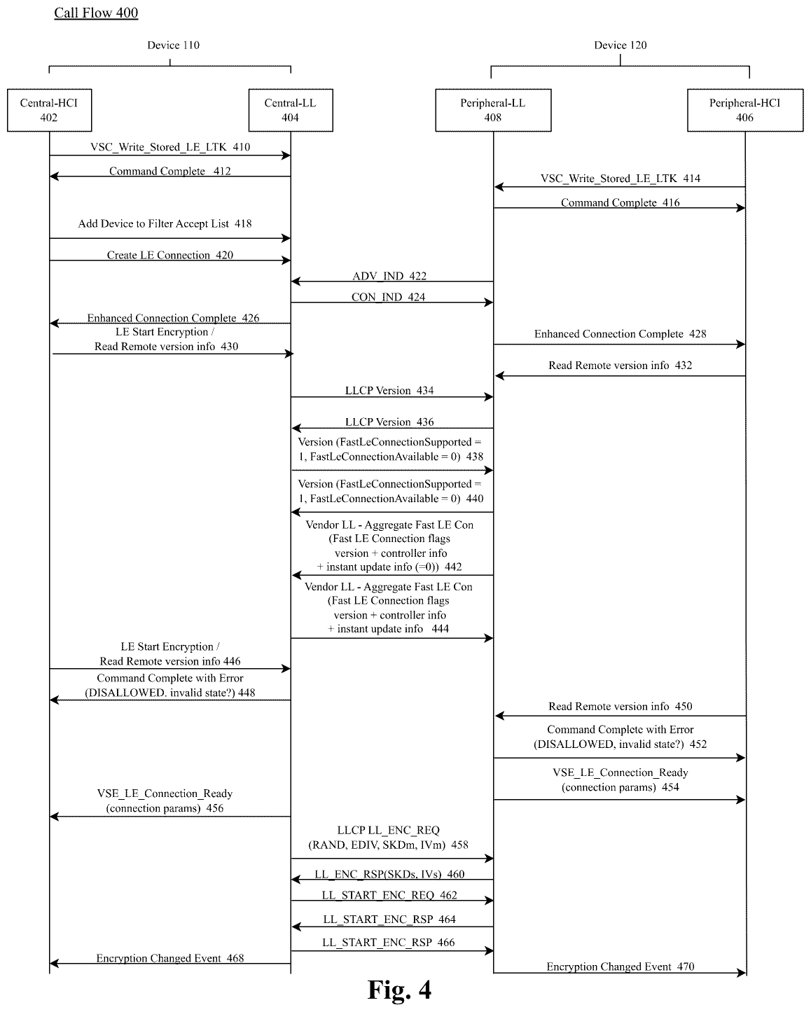

FIG. 4 shows a call flow diagram 400 for establishing a short-range communication link using an over-the-air (OTA) exchange of the controller capabilities and features in an aggregated link layer message according to various example embodiments. In the example of FIG. 4, it may be considered that the devices that are establishing the connection are the devices 110 and 120 of FIG. 1, e.g., the device 110 may be considered to be the central device such as the tablet computer in the above example and the device 120 may be considered to be the peripheral device such as the electronic pen in the above example. In addition, the devices 110 and 120 may also be referred to as peer devices in the below description.

Similar to the call flow 300, the device 110 comprises a central HCI 402 and a central LL 404. Any messages exchanged between the central HCI 402 and the LL 404 in the call flow 400 may occur within the device 110. Similarly, the device 120 comprises a peripheral HCI 406 and a peripheral LL 408 and any messages exchanged between the peripheral HCI 306 and the peripheral LL 308 in the call flow 300 may occur within the device 120.

As described above, in the call flow 300 it was assumed that the devices 110 and 120 had exchanged the respective connection related information using an OOB exchange prior to the call flow 300. In contrast, in the call flow 400, the devices 110 and 120 do not have connection related information for the peer devices prior to the call flow 400 being initiated. Furthermore, in the description of the call flow 400 there are multiple operations that are similar to the operations described above for the call flow 300. These similar operations are mentioned below but further information regarding these operations may be understood from the above description of the call flow 300.

In 410, the connection related information of the device 110 is read from the central HCI 402 by the central LL 404, e.g., the device 110 reads its own connection related information. In 412, the central LL 404 confirms the reading of the connection related information is complete. Operations 410 and 412 are similar to operations 310 and 312.

In 414, the connection related information of the device 120 is read from the peripheral HCI 406 by the peripheral LL 408, e.g., the device 120 reads its own connection related information. In 416, the peripheral LL 404 confirms the reading of the connection related information is complete. Operations 414 and 416 are similar to operations 322 and 324.

In 418, the central HCI 402 adds the peer device to a filter accept list of the central LL 404, e.g., indicating that the device 110 may connect to the device 120 using a short-range communication link. In 420, the central HCI 402 creates a connection for the peer device with the central LL, e.g., there is a socket indicating that any connection with the peer device should be created using a particular type of connection, in this example, a BLE connection. Operations 418 and 420 are similar to operations 334 and 336.

In 422, the peripheral LL 208 performs a BLE advertisement operation. The BLE advertisement operation is a standard BLE advertising operation. In 424, the central LL 404 performs a BLE connection indication response to the advertisement of 422. Again, the BLE connection response is a standard BLE operation that includes a connection request packet sent on one of the primary advertising channels. Operations 422 and 424 are similar to operations 338 and 340.

In 426, the central LL 404 reports to the central HCI 402 that an enhanced connection is complete. This is again a standard BLE operation that indicates a resolved public address once connected to a public peer address. In 428, the device 120 performs a corresponding operation as 426 for the device 110, the peripheral LL 408 reports to the peripheral HCI 406 that an enhanced connection is complete. Operations 426 and 428 are similar to operations 342 and 344.

In 430, the central HCI 402 may send an LE start encryption message and/or a read remote version information message to the central LL 404. One of skill in the art will understand that these message(s) from the host are part of the standard BLE connection process. In this example, the host will start the standard BLE connection process but the controller will not reply to the standard message(s) until the controller understands if an aggregated link layer message is to be used for a fast connection. If the controller determines that the fast connection using the aggregated link layer message is not to be used, the standard BLE connection process may continue. However, in this example of the call flow 400, it will be considered that the aggregated link layer message for fast connection is to be used, so the fall back to the standard BLE connection process is not described further. In addition, there is no requirement that the host start the standard BLE connection process by sending the LE start encryption message and/or a read remote version information message in 430.

In 432, the peripheral HCI 406 may send a read remote version information message to the peripheral LL 408. The operation 432 is the corresponding operation for the device 120 as the operation 430 for the device 110, e.g., a message to start the standard BLE connection process. Similar to 430, the controller of the device 120 will wait to respond to the message until it understands whether the aggregated link layer message is to be used for a fast connection.

In 434, the central LL 404 indicates to the peripheral LL 408 the LLCP version used by the device 110. Similarly, in 436, the peripheral LL 408 indicates to the central LL 404 the LLCP version used by the device 120. Operations 434 and 436 are similar to operations 346 and 346.

In 438, the central LL 404 indicates to the peripheral LL 408 a status of support for fast connection by the device 110 in a version message. The version message may be a new message or it may be an existing version message (e.g., from a standard BLE connection process) that includes additional bits to indicate support for the fast connection. Similar to the version message described above with reference to 350 and 352, the support comprises two indications. The first indication is whether fast connection is supported by the device and the second indication is whether the device 110 has the connection related information for the peer device 120.

In 440, the peripheral LL 408 indicates to the central LL 404 a status of support for fast connection by the device 120 in a version message, e.g., the corresponding operation to the operation 438 performed by the device 110.

In the example of the call flow 300, it was described that for the fast connection to be used, both indications for both devices will be set to positive, e.g., the devices 110 and 120 both support fast connection and have the connection related information for the peer device. In contrast, in the example of the call flow 400, for the fast connection to be used, both indications for both devices do not have to be positive. As long as both devices support fast connection (e.g., the first indication), fast connection may be used because the connection related information may be exchanged OTA as described in further detail below. However, if either of the devices 110 or 120 do not support fast connection, fast connection will not be used and the devices 110 and 120 will fall back to use the standard BLE connection process.

In this example, it may be considered that the first indications in the version message for both devices 110 and 120 are positive (e.g., as shown in 438 and 440, FastLEConnectionSupported=1), but the second indications in the version message for both devices are negative (e.g., as shown in 438 and 440, FastLEConnectionAvailable=0). Thus, in this example, at the completion of 440, both of the devices 110 and 120 are aware that the peer device supports fast connection but they do not have the connection related information for the peer device.

In 442, the peripheral LL 408 sends an aggregated link layer message to the central LL 404. The aggregated link layer message comprises all the connection related information for the device 120 used to establish the short-range communication link in a single message, e.g., the example connection related information described above. In addition, as shown in FIG. 4, the aggregated link layer message also includes an instant update parameter that is set to 0. As described with reference to 354 of the call flow 300, the instant update message indicates a time (or event) at which the devices 110 and 120 should apply the connection related information. Since the device 120 does not have the peer connection related information for the device 110, the instant update parameter is set to 0. As will be described in greater detail below, the central device 110 will provide the instant update parameter.

In 444, the central LL 404 sends an aggregated link layer message to the peripheral LL 408. The aggregated link layer message comprises all the connection related information for the device 110 used to establish the short-range communication link in a single message, e.g., the example connection related information described above. In addition, as shown in FIG. 4, the aggregated link layer message also includes an instant update parameter. As described above, the instant update message indicates a time (or event) at which the devices 110 and 120 should apply the connection related information for the purposes of the fast connection.

Thus, when the central LL 404 sends the aggregated link layer message comprising the instant update message in 444 with the timing (or event) to apply the connection related information, the devices 110 and 120 may then apply the corresponding connection related information to create the short-range communication link.

As described above with reference to 430, in some example embodiments, the host may attempt to start the standard BLE connection process. In these example embodiments, in 446, the host will again attempt to start the standard BLE connection process by the central HCI 402 sending an LE start encryption message and/or a read remote version information message to the central LL 404. However, at this time, the controller will know whether an aggregated link layer message is being used for the fast connection process. If the fast connection process is not being used, the devices 110 and 120 may continue and use the standard BLE connection process. In this example, it was considered that the controller understands that the fast connection process is being used. Thus, in 448, the central LL 404 will send an error message in response to the message sent in 446. This will inform the host that the standard BLE connection process is not being used and the host will discontinue attempting to use the standard BLE connection process. Again, the operations 446 and 448 may not be used if the host does not initiate the standard BLE connection process in 430.

In 450, the peripheral HCI 406 may send a read remote version information message to the peripheral LL 408. The operation 450 is the corresponding operation for the device 120 as the operation 446 for the device 110, e.g., a message to start the standard BLE connection process. Again, in this example, since the controller of the device 120 understands that aggregated link layer message is being used for the fast connection process, in 552, the peripheral LL 408 will send an error message in response to the message sent in 450. This will inform the host that the standard BLE connection process is not being used and the host will discontinue attempting to use the standard BLE connection process. Again, the operations 450 and 552 may not be used if the host does not initiate the standard BLE connection process in 432.

In 454, the peripheral LL 408 will send a connection ready message including the connection related information to the peripheral HCI 406 and in 456 the central LL 404 will send a connection ready message including the connection related information to the central HCI 402 and the devices 110 and 120 will have established the short-range communication link.

The remaining operations of the call flow 400 are related to scenarios where the devices 110 and 120 have stored encryption information for the peer device (e.g., exchanged during a previous connection). The encryption information does not need to be stored for the purposes of performing the fast connection. However, the encryption information may save additional time for short-range communication links that use encryption. The operations 458-470 are identical to the operations 360-372 of the call flow 300 described above and therefore will not be described again.

### Examples

In a first example, a method, comprising sending, to a second device, first connection related information associated with establishing a short-range communication link with the first device, receiving second connection related information associated with establishing the short-range communication link with the second device, establishing the short-range communication link with the second device using the first connection related information and the second connection related information, wherein the establishing further comprises sending, to the second device, an indication the first device supports a fast connection process, sending, to the second device, an indication the first device comprises the second connection related information, receiving, from the second device, an indication the second device supports the fast connection process and receiving, from the second device, an indication the second device comprises the first connection related information.

In a second example, the method of the first example, wherein the short-range communication link is a Bluetooth Low Energy (BLE) link.

In a third example, the method of the first example, wherein the first connection related information and the second connection related information comprise one of (i) a version of a communication protocol to be used for the short-range communication link, (ii) a feature of the communication protocol supported by the corresponding first device or second device, (iii) an enhanced data packet length capability of the corresponding first device or second device or (iv) a physical layer (PHY) capability of the corresponding first device or second device.

In a fourth example, the method of the first example, wherein the first connection related information is sent to the second device via one of a wireless connection or a wired connection between the first device and the second device.

In a fifth example, the method of the first example, wherein the sending the first connection related information to the second device comprises sending the first connection related information to a cloud device, wherein the second device retrieves the first connection related information from the cloud device.

In a sixth example, the method of the first example, wherein the second connection related information is received from the second device via one of a wireless connection or a wired connection between the first device and the second device.

In a seventh example, the method of the first example, wherein the second connection related information is received from a cloud device.

In an eighth example, the method of the first example, further comprising storing the second connection related information in a controller of the first device and writing the second connection related information to a link layer of a protocol stack being executed by the first device.

In a ninth example, the method of the first example, wherein the establishing further comprises sending, to the second device, an instant update information message indicating a time or an event and applying the first and second connection related information to establish the short-range communication link based on the time or an occurrence of the event.

In a tenth example, the method of the first example, wherein the establishing further comprises receiving, from the second device, an instant update information message indicating a time or event and applying the first and second connection related information to establish the short-range communication link based on the time or an occurrence of the event.

In an eleventh example, the method of the first example, further comprising receiving encryption information associated with exchanging encrypted information with the second device over the short-range communication link and exchanging encrypted information with the second device over the short-range communication link using the encryption information.

In a twelfth example, the method of the eleventh example, wherein the encryption information comprises a long term key (LTK) associated with the second device.

In a thirteenth example, a processor configured to perform any of the methods of the first through twelfth examples.

In a fourteenth example, a device comprising a transceiver configured to communicate wirelessly with other devices and a processor communicatively coupled to the transceiver and configured to perform any of the methods of the first through twelfth examples.

In a fifteenth example, a method, comprising receiving, from a second device, an indication the second device supports a fast connection process for a short-range communication link, receiving, from the second device, an indication the second device does not comprise first connection related information associated with establishing the short-range communication link with the first device, sending, to the second device, an indication the first device supports the fast connection process, sending, to the second device, an indication the first device does not comprise second connection related information associated with establishing the short-range communication link with the second device, sending, to the second device, a first aggregated link layer message comprising a complete set of the first connection related information to establish the short-range communication link with the second device, receiving, from the second device, a second aggregated link layer message comprising a complete set of the second connection related information to establish the short-range communication link with the second device and establishing the short-range communication link with the second device using the first and second connection related information.

In a sixteenth example, the method of the fifteenth example, wherein the short-range communication link is a Bluetooth Low Energy (BLE) link.

In a seventeenth example, the method of the fifteenth example, wherein the first connection related information and the second connection related information comprise one of (i) a version of a communication protocol to be used for the short-range communication link, (ii) a feature of the communication protocol supported by the corresponding first device or second device, (iii) an enhanced data packet length capability of the corresponding first device or second device or (iv) a physical layer (PHY) capability of the corresponding first device or second device.

In an eighteenth example, the method of the fifteenth example, wherein the first aggregated link layer message further comprises an instant update information parameter indicating a time or an event, wherein the short-range communication link is established based on the time or an occurrence of the event.

In a nineteenth example, the method of the fifteenth example, wherein the first aggregated link layer message further comprises an instant update information parameter set to null.

In a twentieth example, the method of the fifteenth example, further comprising attempting to start a standard connection process for the short-range communication link and receiving an error message indicating the standard connection process is unavailable.

In a twenty first example, the method of the fifteenth example, further comprising receiving encryption information associated with exchanging encrypted information with the second device over the short-range communication link and exchanging encrypted information with the second device over the short-range communication link using the encryption information.

In a twenty second example, the method of the twenty first example, wherein the encryption information comprises a long term key (LTK) associated with the second device.

In a twenty third example, a processor configured to perform any of the methods of the fifteenth through twenty second examples.

In a twenty fourth example, a device comprising a transceiver configured to communicate wirelessly with other devices and a processor communicatively coupled to the transceiver and configured to perform any of the methods of the fifteenth through twenty second examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as ios, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure covers modifications and variations of this disclosure provided they come within the scope of the appended claims and their equivalent.

What is claimed is:

1. An apparatus comprising processing circuitry configured to:
generate, for transmission to a device, first connection related information associated with establishing a short-range communication link;
process, based on signals received from the device, second connection related information associated with establishing the short-range communication link with the device;
establish the short-range communication link with the device using the first connection related information and the second connection related information, wherein to establish the short-range communication link the processing circuitry is configured to:
generate, for transmission to the device, an indication the apparatus supports a fast connection process;
generate, for transmission to the device, an indication the apparatus comprises the second connection related information;
process, based on signals received from the device, an indication the wireless device supports the fast connection process; and
process, based on signals received from the device, an indication the device comprises the first connection related information.

2. The apparatus of claim 1, wherein the short-range communication link is a Bluetooth Low Energy (BLE) link.

3. The apparatus of claim 1, wherein the first connection related information and the second connection related information comprise one of (i) a version of a communication protocol to be used for the short-range communication link, (ii) a feature of the communication protocol supported by the apparatus or device, (iii) an enhanced data packet length capability of the apparatus or device or (iv) a physical layer (PHY) capability of the apparatus or device.

4. The apparatus of claim 1, wherein the first connection related information is sent to the device via one of a wireless connection or a wired connection.

5. The apparatus of claim 1, further comprising transceiver circuitry configured to send the first connection related information to a cloud device for retrieval by the device.

6. The apparatus of claim 1, wherein the second connection related information is received via one of a wireless connection or a wired connection.

7. The apparatus of claim 1, wherein the second connection related information is received from a cloud device.

8. The apparatus of claim 1, wherein the processing circuitry is further configured to:
store the second connection related information in a controller; and
write the second connection related information to a link layer of a protocol stack being executed by the processing circuitry.

9. The apparatus of claim 1, wherein the processing circuitry establish the short-range communication link based on being configured to:
generate, for transmission to the device, an instant update information message indicating a time or an event; and
apply the first and second connection related information to establish the short-range communication link based on the time or an occurrence of the event.

10. The apparatus of claim 1, wherein the processing circuitry establish the short-range communication link based on being configured to:
process, based on signals received from the device, an instant update information message indicating a time or event;
apply the first and second connection related information to establish the short-range communication link based on the time or an occurrence of the event.

11. The apparatus of claim 1, wherein the processing circuitry is further configured to:
process encryption information associated with exchanging encrypted information with the device over the short-range communication link; and
generate, for exchange with the device over the short-range communication link using the encryption information, encrypted information.

12. The apparatus of claim 11, wherein the encryption information comprises a long term key (LTK) associated with the second device.

13. An apparatus comprising processing circuitry configured to:
process, based on signals received from a device, an indication the device supports a fast connection process for a short-range communication link;
process, based on signals received from the device, an indication the second device does not comprise first connection related information associated with establishing the short-range communication link with the first device;
generate, for transmission to the device, an indication the apparatus supports the fast connection process;
generate, for transmission to the device, an indication the apparatus does not comprise second connection related information associated with establishing the short-range communication link with the device;
generate, for transmission to the device, a first aggregated link layer message comprising a complete set of the first connection related information to establish the short-range communication link with the device;
process, based on signals received from the device, a second aggregated link layer message comprising a complete set of the second connection related information to establish the short-range communication link with the device; and
establish the short-range communication link with the device using the first and second connection related information.

14. The apparatus of claim 13, wherein the short-range communication link is a Bluetooth Low Energy (BLE) link.

15. The apparatus of claim 13, wherein the first connection related information and the second connection related information comprise one of (i) a version of a communication protocol to be used for the short-range communication link, (ii) a feature of the communication protocol supported by the apparatus or device, (iii) an enhanced data packet length capability of the apparatus or device or (iv) a physical layer (PHY) capability of the apparatus or device.

16. The apparatus of claim 13, wherein the first aggregated link layer message further comprises an instant update information parameter indicating a time or an event, wherein the short-range communication link is established based on the time or an occurrence of the event.

17. The apparatus of claim 13, wherein the first aggregated link layer message further comprises an instant update information parameter set to null.

18. The apparatus of claim 13, wherein the processing circuitry is further configured to:
attempt to start a standard connection process for the short-range communication link; and
receive an error message indicating the standard connection process is unavailable.

19. The apparatus of claim 13, wherein the processing circuitry is further configured to:
process encryption information associated with exchanging encrypted information with the device over the short-range communication link; and
generate, for exchange with the device over the short-range communication link using the encryption information, encrypted information.

20. An apparatus comprising processing circuitry configured to:
generate, for transmission to a device, an indication the apparatus supports a fast connection process;
generate, for transmission to the device, an indication the apparatus comprises first connection related information for the fast connection process;
process, based on signals received from the device, an indication the device supports the fast connection process; and
process, based on signals received from the device, an indication the device comprises second connection related information.
